(19) United States
(12) Patent Application Publication
(10) Pub. No.: US 2023/0036418 A1
(43) Pub. Date: Feb. 2, 2023

(54) SYSTEMS AND METHODS FOR GENERATING MULTI-LAYER HOLOGRAM PROJECTIONS

(71) Applicant: Dimensional Holo Imaging Inc., Dashwood (CA)

(72) Inventor: Anthony Leendertz, Dashwood (CA)

(21) Appl. No.: 17/875,162

(22) Filed: Jul. 27, 2022

Related U.S. Application Data
(60) Provisional application No. 63/226,073, filed on Jul. 27, 2021.

(51) Int. Cl. G03H 1/26; G03H 1/22; G03B 21/28; G03B 21/13

(52) U.S. Cl. CPC G03H 1/26; G03B 21/13; G03B 21/28; G03H 1/22; G03H 2001/2615

(57) ABSTRACT

Systems and methods for generating multi-layer hologram projections are described. For example, a system generally comprises at least two projection layers in a spaced-apart arrangement; at least one layer-specific projector device associated with each of the at least two projection layers, each layer-specific projector device being configured to project one or more images on an associated projection layer; and a processor coupled to each of the at least one layer-specific projector device, the processor being configured to control each layer-specific projector device to project one or more images on the corresponding projection layer.

### CROSS-REFERENCE TO RELATED APPLICATION

This application claims the benefit of United States Provisional Pat. Application No. 63/226,073 filed Jul. 27, 2021; the entire contents of United States Provisional Pat. Application No. 63/226,073 is hereby incorporated herein in its entirety.

### FIELD

Various embodiments are described herein that generally relate to holograms, hologram images and three-dimensional (3D) image projections, and in particular to a method and system for generating multi-layer hologram projections.

### BACKGROUND

The following is not an admission that anything discussed below is part of the prior art or part of the common general knowledge of a person skilled in the art.

The ability to generate realistic 3D images and/or video presentations has found broad applicability in various fields, including in producing virtual concerts (e.g., generating 3D mimics of live bands on stage) as well as educative tools in museum settings (e.g., generating educative 3D renderings).

Over the years, various methods and techniques have been explored as potential avenues for generating realistic 3D images and/or video presentations. One promising technique has been the use of holographic image projection systems. Existing methods for generating hologram projections, however, suffer from a number of significant drawbacks. For example, existing systems often fail to mimic the true sensation of viewing a real world 3D object. In many cases, this can result from a lack of ability to replicate a depth of field perception from multiple viewing perspectives. For example, many systems may generate hologram projections that are viewable from only a single viewing angle, with the 3D effect being degraded or lost when the observer shifts their viewing perspective (i.e., by moving laterally from side-to-side). Other problems relate to the high processing power required to generate the holographic images and/or video projections.

### SUMMARY OF VARIOUS EMBODIMENTS

The following introduction is provided to introduce the reader to the more detailed discussion to follow. The introduction is not intended to limit or define any claims or as yet unclaimed invention. One or more inventions may reside in any combination or subcombination of the elements or process steps disclosed in any part of this document including its claims and figures.

In accordance with a broad aspect of the teachings herein, there is provided a system for multi-layer hologram projections, the system comprises: at least two projection layers in a spaced-apart arrangement; at least one layer-specific projector device associated with each of the at least two projection layers, each layer-specific projector device being configured to project one or more images on an associated projection layer; and a processor coupled to each of the at least one layer-specific projector device, the processor being configured to control each layer-specific projector device to project one or more images on the corresponding projection layer.

In at least one embodiment, each of the layer-specific projector devices is an ultra-short throw projector.

In at least one embodiment, the at least two projection layers comprises a first projection layer, a second projection layer and a third projection layer.

In at least one embodiment, the first and second layers are each formed of a holographic mesh, the third layer is formed of a solid reflective projection material.

In at least one embodiment, each of the at least two projection layers has one of a planar shape and a curved shape.

In at least one embodiment, the system further comprises a mobile trussing and crank stand assembly for supporting the at least two projection layers.

In at least one embodiment, a rearward layer of the at least two projection layers comprises at least one black scrim covering one or more of a top portion and a bottom portion of the layer.

In at least one embodiment, the at least one layer-specific projector device comprises a top projector device and a bottom projector device, and the processor is further configured to control the top projector device to display a portion of an image and the bottom projector device to display a remaining portion of the image.

In at least one embodiment, the processor is further configured to: determine a time range of overlap between a primary image projected by a first layer-specific projector device on a first projection layer, and a secondary image projected by a second layer-specific projector device on a second projection layer; generate an object mask corresponding in shape to the primary image; control a third layer-specific projector device to project the object mask over the secondary image on the second projector layer during the time range; an de-activate the object mask after the time range has elapsed.

In at least one embodiment, the object mask comprises a gaussian blur.

In accordance with another broad aspect of the teachings herein, there is provided a method for creating multi-layer hologram projections comprising: providing at least two projection layers in a spaced-apart arrangement; providing at least one layer-specific projector device associated with each of the at least two projection layers, each layer-specific projector device being configured to project one or more images on an associated projection layer; and controlling each layer-specific projector device to project one or more images on the corresponding projection layer.

In at least one embodiment, each of the layer-specific projector devices is an ultra-short throw projector.

In at least one embodiment, the at least two projection layers comprise a first projection layer, a second projection layer and a third projection layer.

In at least one embodiment, the first and second layers are each formed of a holographic mesh, the third layer is formed of a solid reflective projection material.

In at least one embodiment, each of the at least two projection layers has one of a planar shape and a curved shape.

In at least one embodiment, the method further comprises supporting the at least two projection layers on a mobile trussing and crank stand assembly.

In at least one embodiment, a rearward layer of the at least two projection layers comprises at least one black scrim covering one or more of a top portion and a bottom portion of the layer.

In at least one embodiment, the at least one layer-specific projector device comprises a top projector device and a bottom projector device, and the method further comprises: controlling the top projector device to display a portion of an image and the bottom projector device to display a remaining portion of the image.

In at least one embodiment, the method further comprises determining a time range of overlap between a primary image projected by a first layer-specific projector device on a first projection layer, and a secondary image projected by a second projector device on a second layer-specific projection layer; generating an object mask corresponding in shape to the primary image; controlling a third layer-specific projector device to project the object mask over the secondary image on the second projector layer during the time range; and de-activating the object mask after the time range has elapsed.

In at least one embodiment, the object mask comprises a gaussian blur.

Other features and advantages of the present application will become apparent from the following detailed description taken together with the accompanying drawings. It should be understood, however, that the detailed description of the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiments, and which are now described. The drawings are not intended to limit the scope of the teachings described herein.

FIG. 1 shows an illustration of an example embodiment for multi-layer hologram projections in accordance with some teachings provided herein.

FIG. 2A shows an example configuration of multi-layer projection screens, according to at least one embodiment described herein.

FIG. 2B shows an example configuration of multi-layer projection screens with example image projections.

FIG. 2C shows an example configuration of multi-layer projection screens, according to at least one embodiment described herein.

FIG. 2D shows an example configuration of curved multi-layer projection screens, according to at least one embodiment described herein.

FIG. 2E shows an example configuration of curved multi-layer projection screens, according to at least one other embodiment described herein.

FIG. 3 shows an example embodiment of a mounting assembly for multi-layer projection screens.

FIG. 4A shows an example configuration of projectors positioned relative to projection screens.

FIG. 4B shows an example configuration of projectors positioned relative to a wide projection screen.

FIG. 4C shows an example configuration for the multi-layer hologram presentation system, according to at least one embodiment described herein.

FIG. 4D shows a perspective view of an example configuration for the multi-layer hologram presentation system, according to at least one embodiment described herein.

FIG. 4E shows an example configuration for the multi-layer hologram presentation system using a staggered screen arrangement.

FIG. 5A shows an example arrangement of a normal projector device relative to one or more projection screens.

FIG. 5B shows an example arrangement of an ultra-short throw (UST) projector device relative to one or more projection screens.

FIG. 5C shows an example embodiment of an UST projector device placed near a bottom portion of a projection screen.

FIG. 5D shows an example embodiment of an UST projector device placed near a top portion of a projection screen.

FIG. 6A shows an example projection screen with layered scrims, according to at least embodiment described herein.

FIG. 6B shows an example double projector arrangement, according to at least one embodiment described herein.

FIG. 7A shows various illustrations of image bleeding between projection screens.

FIG. 7B shows various illustrations of a mask that may be used to minimize image bleeding.

FIG. 7C shows an example embodiment for a process flow for a method for generating image masks to prevent image bleed through.

FIG. 8A is an example embodiment for a hardware configuration for a multi-layer hologram projection system.

FIG. 8B is an example embodiment of a hardware block diagram for a computer terminal that may be used in the system of FIG. 8A.

FIG. 9A is a simplified block diagram of example interconnected software modules, according to at least one embodiment described herein.

FIG. 9B is a simplified block diagram of example interconnected software modules, according to at least one embodiment described herein.

FIG. 10A is an example graphical user interface for controlling a multi-layer hologram projection system, according to at least one embodiment described herein.

FIG. 10B is another example graphical user interface for controlling a multi-layer hologram projection system, according to at least one embodiment described herein.

FIG. 11 is an example embodiment of a method for virtual lighting of hologram objects using a multi-layer hologram projection system.

Further aspects and features of the example embodiments described herein will appear from the following description taken together with the accompanying drawings.

### DETAILED DESCRIPTION OF THE EMBODIMENTS

As explained in the background, there is a desire for a method and system for generating realistic three-dimensional (3D) images and/or video presentations.

### I. General System Overview

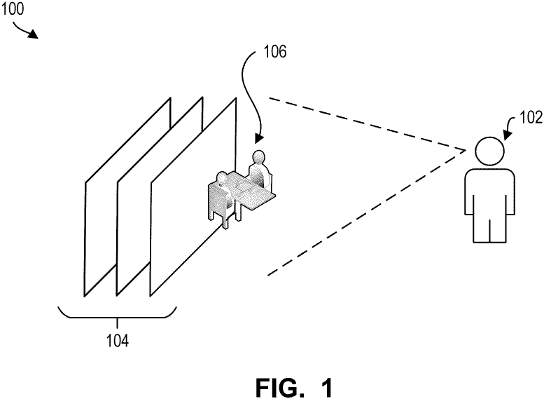

Reference is now made to FIG. 1, which shows a high-level overview illustration of an example embodiment for an arrangement 100 for generating multi-layer hologram projections.

As shown, embodiments provided herein allow for generating the appearance of 3D holographic projections (i.e., a 3D image projection 106) to a viewing viewer 102 through a plurality of projection layers (layers may also be referred to as screens) 104 used in conjunction with projector devices (not shown in FIG. 1). The provided multi-layer hologram projection system allows for generating a depth of field perception that mimics the sensation of viewing real world objects.

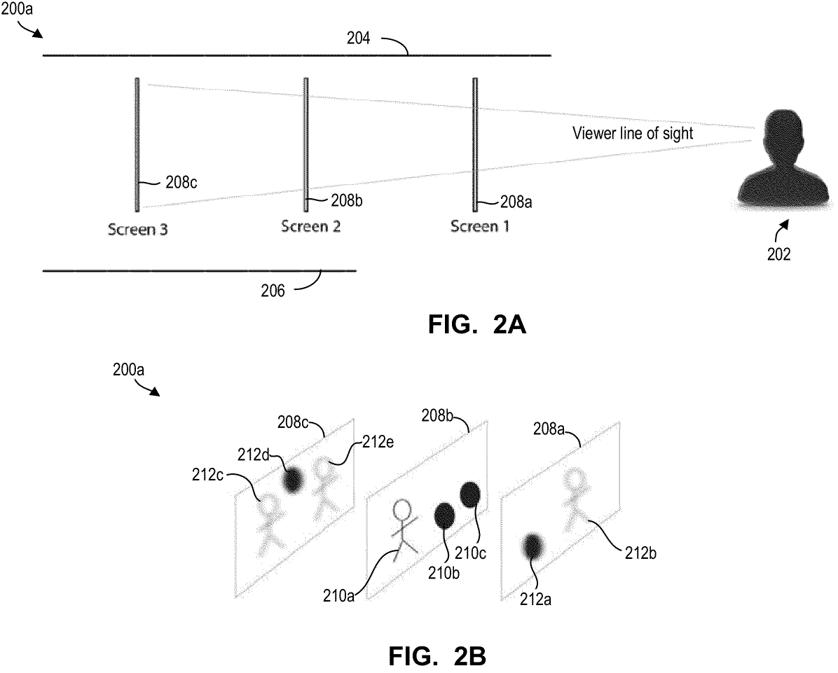

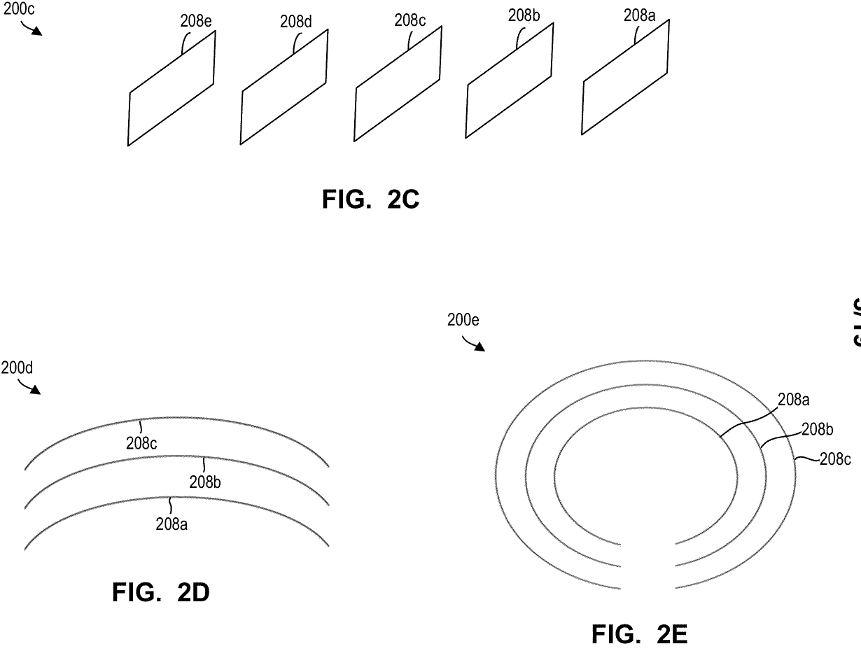

Reference is now made to FIGS. 2A ― 2E, which show further illustrations of the multi-layer hologram projection system.

As shown in FIG. 2A, the multi-layer hologram projection system may include an arrangement 200a that includes a number of projection layers (or projection screens) 208a-208c arranged in a spaced-apart and cascaded fashion, such that each projection layer is generally disposed either rearwardly or forwardly of the other projection layers. In the illustrated embodiment, the system is shown to include three projection layers: a first forward projection layer 208a, a second middle projection layer 208b, and a third rearward projection layer 208c. As used herein, a projection layer refers to a screen surface that is used to display images projected by one or more projector devices. In at least one embodiment, a minimum of two projection layers are provided to enable the appearance of realistic 3D holographic images. FIG. 2C shows an example setup 200c that includes up to five cascaded layers 208a ― 208e.

The projection layers, which form the multi-layer hologram projection system, may be located in either an outdoor or indoor setting. In an indoor setting, the screens can be extended at least part way between the ceiling of the room 204 and the floor of the room 206.

As best shown in FIG. 2B, hologram projections are generated by projecting a series of individual two dimensional (2D) images on each individual projection surface 208. As provided in greater detail, the projection of 2D objects on each screen 208 occurs through the use of projector devices that are specifically designated for each screen (otherwise known herein as screen-specific projector devices or layer-specific projector devices).

In contrast to current methods for generating holographic 3D projections, the provided embodiments do not rely on generating a single true 3D projection. In particular, existing hologram projection systems may project the same image on multiple screens to extend the image into a 3D projection (i.e., a single square image is duplicated on two projection screens to appear as a 3D cube). Rather, in accordance with embodiments described herein, a series of separate and individual 2D image objects are projected on different screens to mimic the appearance of a 3D projection. For example, in FIG. 2B, a first set of images 212a, 212b may be projected on the first layer 208a, a second set of images 210a, 210b 210c may be projected on the second layer 208b, and a third set of images 212c, 212d, 212e may be projected on a third layer 208c. Each set of images projected on each separate projection layer may correspond to separate projected content. The resulting effect is that as the viewer focuses on a projected image on one projection layer (i.e., images 210a ― 210c on mid-layer 208b), the images on the remaining projection layers are removed from focus (i.e., objects 212a ― 212e), thereby forcing the viewer to re-focus on each image on each layer. The mental effect of this configuration is to manipulate the viewer’s perception and physiological interpretation so as to generate the illusion of depth of field perception whereby a viewer’s brain associates the multiple viewed staggered 2D image objects as various 3D image objects.

To this end, an appreciated advantage of the disclosed multi-layer hologram projection systems described herein is that, as the viewer adjusts their line-of-sight (i.e., by moving side-to-side), the hologram images 210, 212 also appear to move in relation to each other. This, in turn, provides the visual effect of the projections interacting with each other as real world solid objects. Accordingly, in one example application, a hologram of four objects may be projected in a single file line. Viewing the hologram from a central perspective, the viewer 202 may only observe the first projected object in the lineup. However, in moving side-to-side, the viewer 202 can re-adjust their viewing angle, and observe “behind” or “past” the first projected image to view the other projected images arranged in the single file line formation. This is because as the viewer shifts from their viewing angle, each layer shifts accordingly. Existing methods for generating 3D holograms are unable to impart the same level of varied perception with the same real-world viewing effect and without the need for additional viewing accessories (i.e., 3D viewing glasses).

The projection screens 208 may have any suitable shape or design. For example, FIG. 2A shows an example where each screen has a planar rectangular shape. FIG. 2D shows another example multi-layer screen configuration 200d, whereby at least some of the screens 208a-208c have a partially curved structure. FIG. 2E shows yet another example embodiment for a multi-layer screen configuration 200e wherein at least some of the screens 208a-208c have a near 360° projection surface (i.e., 300° curvature). The increased curvature of the screens can, in some cases, generate an enhanced illusion of shifting projected hologram images moving around the viewer 200 so as to impart a virtual reality experience.

In at least one embodiment, each projector layer may have a width of about 30 feet and about 100 feet, and a height of about 10 feet to about 30 feet.

The projection surfaces 208, forming the multi-layer hologram projections system, may comprise transparent film or reflective mesh. This may facilitate multi-layer projection of images using more than one projecting device.

In at least some embodiments, different types of projection materials may be used for each projection layer. In one example embodiment, where three projection screens are provided, the first or front projection layer 208a may be formed of a holographic mesh, such as a dark colored mesh that may appear transparent when lit from behind. The projection layer may be made, for example, of a fine bug net-type material that may be see-through transparent, but may also have some reflective properties. One example of such type of material is Nebula Net ™ mesh from Rose Brand ®. In some cases, the more transparent the material is, the closer to darker the mesh may be and the brighter (i.e., higher lumens) the images provided by the projector may be to achieve a clear image.

The second projection layer (e.g., mid-layer 208), may be a gain layer, and may have a more light grey tone. In general, a grey tone mesh can provide more reflectivity than black colored meshes, and can require less projector brightness while maintaining a high gain structure (the gain of a projection layer may refer to the level of brightness of that projection layer). In some embodiments, the gain structure of the second projection layer 208 can be twice as bright as the first layer mesh, but may also be more visible. The gain structure may be brighter on the second projection layer 208 as the intensity of the projected images may decrease as a result of the first projection layer. In this sense, the second projection layer scrim may be more transparent than the first projection layer or the projector may be brighter than the first projection layer, and the gain structure of the second projection layer may increase anywhere from 20 - 50% in brightness relative to the first projection layer. By combining two mesh surfaces, the brightness of the second layer may match the brightness of the first projection layer, despite the projection being approximately twice as bright.

The third projection layer (i.e., rear projection layer 208c), may be a solid reflective projection material, rather than a mesh. In some cases, the third projection layer may also have a grey tone color. The function of the third and rearward projection layer is to allow the gain structure to be brighter, as this projection layer has more surface for projected content. In some embodiments, the rear projection layer may also be see through in cases where there are no background reflections.

Using this multi-layer projection configuration, the gain of the projected content may increase from the first projection layer to the third projection layer. In this manner, optically, the gain of the image brightness remains the same when taking into consideration the loss of projector intensity as a viewer observes through each sequential layer. In other embodiments, the power of the projector can also be increased to increase the gain brightness of each image on each projection layer. In some embodiments, where more than three projection layers are provided in the system, the gain structure is balanced across the projection layers by adjusting projector intensity and/or the reflectiveness of each projection layer.

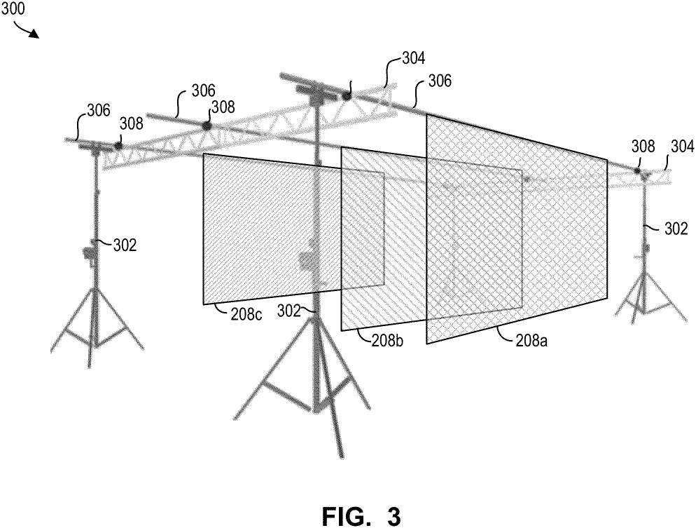

Reference is now made to FIG. 3, which shows an example mounting assembly 300 for multi-layered hologram presentation, according to at least some embodiments.

In the illustrated example embodiment, the mounting assembly comprises a mobile trussing and crank stand assembly 300 for supporting and mounting various elements of the multi-layer holographic projection system, including mounting and supporting the projection screens 208a ― 208c, and in some cases the projectors. The mobile trussing and crank stand system 300 can facilitate easy and transportable setup of the projection system.

As shown, assembly 300 can include one or more crank stands 302, as well as one or more global trusses 304 supported by, and extending between the crank stands 302. Global trusses 304 may, in turn, support one or more beams 306 that extend between the trusses 304 and may further couple to each truss 304 using one or more connectors (e.g., clamps 308). Each beam 306 may further support one of the projection screens 208a, 208b and 208c, and can be laterally spaced apart so as to achieve any desired spacing distance between consecutive screens 208. In the illustrated example, the assembly 300 may be about 13 feet high, about 30 feet wide and about 18 feet deep. Each of the poles or beams 306 can measure about 30 feet x about 12 feet. In some embodiments, the projectors can be mounted onto the trusses 304, or otherwise may be placed on a venue ceiling or floor.

In at least one embodiment, a cover (i.e., a fire retardant (FR) black cover) can enclose the entire assembly structure 300. The cover may comprise, for example, a dark fabric such as a black or dark grey fabric. The cover can be used to enclose the top and sides of the assembly structure 300 to filter out surrounding light pollution that may otherwise degrade the hologram projection displayed on each projection layer 208. Further, by creating an environment of near darkness when the light hologram projections are displayed, the viewer 102, 202 is unable to judge which projection screen the hologram is projected on. More particularly, in a near blacked out environment, the projection screens are not visible to the viewer 102, 202, which generates the appearance of an “infinite” depth of field perception.

In other embodiments, other mounting assembly structures can be used to mount and support the various elements of the multi-layer hologram projection system. For example, an outdoor mobile stage can be used where the projection screens are mounted to a roof of the mobile stage. In other cases, rigging points in a venue can be used to attach and support raised global trussing.

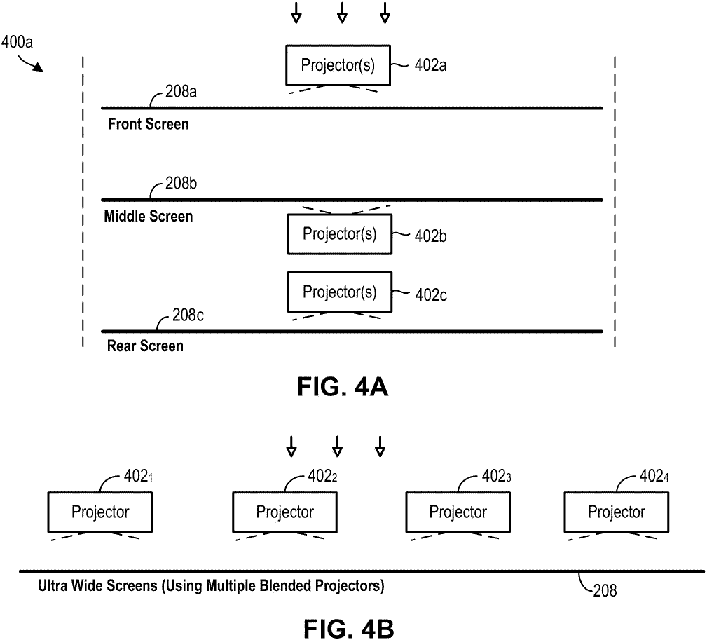

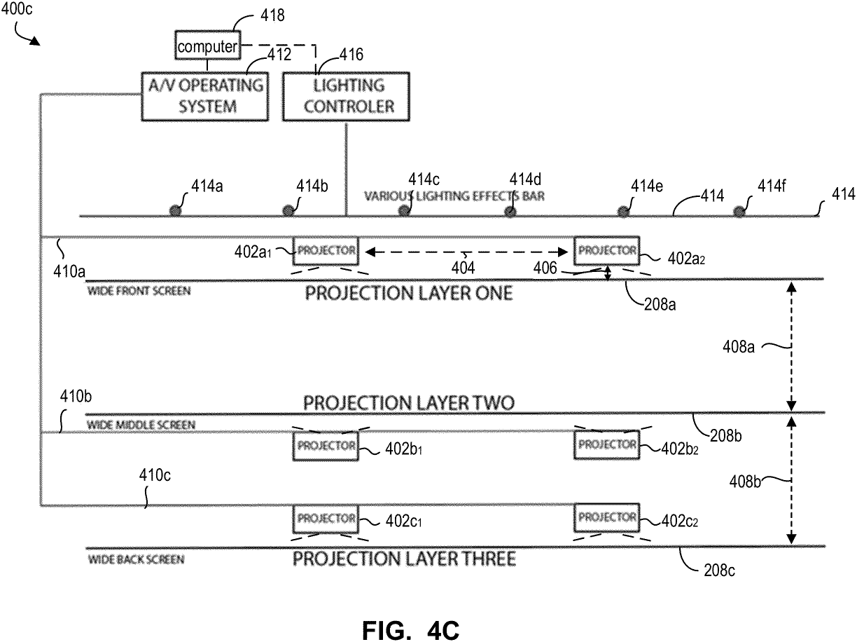

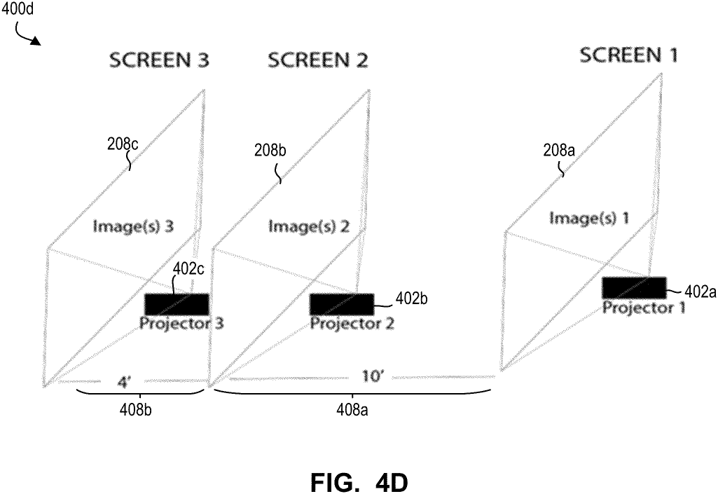

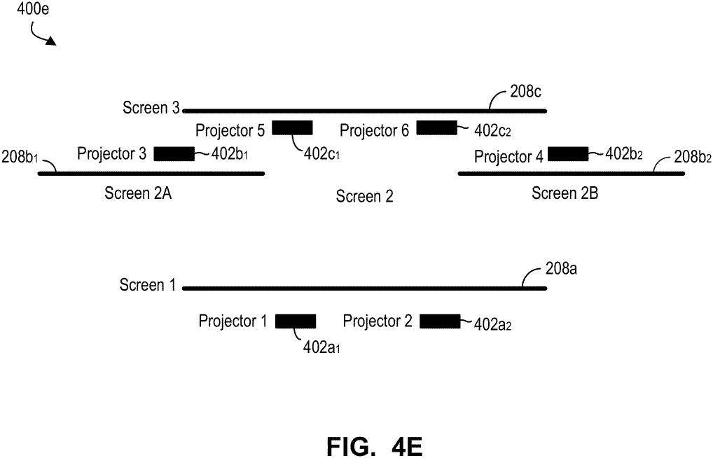

Reference is now made to FIGS. 4A and 4B, which illustrate various example embodiments of projector configurations for the multi-layer hologram projection systems described herein.

FIG. 4A illustrates a projector configuration 400a in accordance with at least one example embodiment. In this configuration, each projection layer or projection screen 208 includes one or more designated projectors 402. For instance, in an embodiment that includes three projection screens, the first projection screen 208a may receive images from one or more designated projectors 402a, the second projection screen 208b may receive images from one or more designated projectors 402b and the rear projection screen 208c may also receive images from one or more designated projectors 402c. Depending on space limitations and the distance between the projection screens, in some cases, a projector can be placed forwardly of its respective projection screen (i.e., projectors 402a, 402c), or otherwise rearwardly of the its respective projection screen (i.e., projector 402b). In at least some embodiments, projectors may be arranged such that they generate projection beams that cross (i.e., cross projection beams). For example, projectors 402b and 402c can generally face each other such that projector 402c projects on the middle projection screen 208c, and projector 402b projects on the rear projection screen 208c.

As best shown in FIG. 4B, in at least some embodiments, where an ultrawide projection screen 208 is provided (e.g., a width of greater than about 60 feet), multiple projectors 402₁ - 402₄ may be provided, whereby each projector 402₁ - 402₄ illuminates a portion of the screen 208 (i.e., a lateral or horizontal portion along the width of the screen 208). In some cases, the portions projected by each projector 402₁ - 402₄ may overlap such as to allow the use of edge blending projection methods to increase the width of the projected surface (e.g., the surface of the ultrawide projection screen 208 that receives projected images).

In at least one embodiment, each projector 402 may have a brightness of about 3,500 to about 20,000 lumens (or greater), based on the lighting conditions, and may have a high contrast ratio to present maximum color depth exceeding about 200,000:1 (e.g., 2,500,000:1 resolution projectors). In some embodiments, projectors can also be vertically stacked to increase the projected lumens or brightness if needed. For example, two projectors may be directly vertically stacked and configured to display the same image or image portion on the same area of the projection screen so as to increase the projection brightness of that image or image portion on the projection screen. As explained in greater detail herein, the inventor has appreciated that ― in contrast to conventional hologram projector systems which rely on one or more projectors to project on multiple projection screens ― the use of screen-specific projectors 402 can enhance the quality and realism of the holographic presentation by having separate layers of displayed images on each projection screen.

While FIGS. 4A and 4B show example cases with three projection screens, any number of projection screens may be provided with each projection screen having a corresponding projector device. In some cases, the addition of projection layers may require balancing the intensity of the projection on multiple projection screens, which can be achieved through higher powered projectors and/or adjusting the brightness of the projectors.

Reference is now made to FIG. 4C, which shows an example configuration 400c for the multi-layer hologram presentation system, accordingly to at least one embodiment.

In this example configuration, six projectors 402 are provided in the hologram presentation system. As shown, two projectors 402a₁, 402a₂ are positioned in front of the front projection screen 208a to display images thereon. In some cases, the projectors 402a are mounted on a trussing (e.g., trussing 304 in FIG. 3) and are oriented to projected downwards onto the front screen 402a. In other cases, the projectors 402a₁, 402a₂ are placed on or near ground level and oriented to project upwardly onto the projection screen. Two projectors 402b₁, 402b₂ are also disposed between the middle projection layer 208b and rear projection layer 208c, and are directed to project images onto the back to the second projection layer 208b. Additionally, two projectors 402c₁, 402c₂ are also located between the middle projection layer 208b and rear projection layer 208c, and are directed to project images on the third and rearmost projection screen 208c. In some cases, the projectors 402c₁, 402c₂ are disposed at or near ground level and are oriented to project images upwardly.

In at least one embodiment, in respect of each set of projectors for each projection layer (e.g., projectors 402a₁, 402a₂), the projectors may have a lateral spacing 404 that is approximately 10 to about 12 feet to allow the projector images to overlap for edge blending. The forward spacing 406 of each set of projectors, from a respective projection layer 208, may be approximately 4 feet. In other embodiments, other forward spacing distances 406 may be used to allow the projectors to cover the projection surface. In some embodiments, each projector 402a₁, 402a₂ may be placed at a forward spacing distance 406 within a range of about 0.5 to about 5 ft from a respective projection screen. As explained below, the close proximity of the projectors to the screens 208 uses recently developed ultra-short throw (UST) projector technology.

In some embodiments, the distance 408a between the first and second screens 208a, 208b may be approximately 8 to 10 feet, while the distance 408b between the second and third screens 208b, 208c may be approximately 4 feet. Accordingly, the total distance between the front screen and back screen 208a, 208c may be approximately 14 feet (see also FIG. 4D). As provided in greater detail, these distances may minimize the incidences of bleed through (i.e., image spill) between the middle and front projectors on other projector surfaces. In other cases, however, the spacing between the screens 208 may also be adjustable.

In at least one embodiment some embodiments, projection layers may be used which include laterally spaced apart and staggered projection screens. For example, referring to FIG. 4E, shown therein is an example configuration for a multi-layer hologram presentation system 400e that uses a staggered screen arrangement across multiple screens. The system 400e includes a first projection layer (e.g., Screen 1 ― projection screen 208a), a staggered second projection layer (e.g., projection layer 2 including staggered Screens 2A and 2B ― projection screens 208b₁ and 208b₂) and a third projection layer (e.g., Screen 3 ― projection screen 208c). Projectors 1 and 2 (e.g., projectors 402a₁ and 402a₂) are positioned in close proximity and facing Screen 1, projector 3 (e.g., projector 402b₁) is positioned in close proximity and on an opposite side of Screen 2A (e.g., projector 402b₂) to face projectors 402a₁ and 402a₂, in close proximity with Screen 2B and projectors 5 and 6 (e.g., projectors 402c1 and 402c2) are positioned in close proximity with and facing Screen 3 such that they are facing in the same direction as projectors 402a₁ and 402a₂.

Referring back to FIG. 4C, each of the projectors 402a₁-402c₂ may be connected, via a respective connection 410, to an audio/visual (A/V) operating system 412 (i.e., a software-based operating system) that is hosted, for example, on a computer terminal 418 (which may also just be referred to as a computer) having a monitor. The A/V system 412 can be used to control the output video and audio from each of the projectors 402. The computer terminal 418 with monitor may be provided for use by an operator. Computer terminal 418 may also host a lighting controller 416 module. The monitor is a display which may present a control graphical user interface (GUI) to the operator to allow the operator to control the various operations of the projectors 402a₁-402c₂ (i.e., via the A/V system 412), as well as controlling the lighting effects via the lighting controller 416. While the illustrated embodiment shows wired connections 410 between the computer terminal 418 hosting the A/V system 412 and the lighting controller 416, and the projectors 402 and lighting effects bar 414, in other cases, either wired and/or wireless communication methods may be used. The computer terminal 418, which may also just be referred to as a computer, includes at one or more processors for executing software that configures the processor(s) to operate in new ways for controlling the system. For example, the processor(s) in turn control the projectors to operate in a certain manner.

The system may also include a lighting effects bar 414. The lighting effects bar 414 may include one or more lighting elements (e.g., LEDs) 414a - 414f which are each positioned to light a different portion of the projection screen 208. The lighting elements 414a ― 414f may be connected to, and controlled by, the lighting controller 416. In at least some embodiments, the lighting effects can enhance the projected performance in a similar manner as lighting effects in a live performance.

To this end, the inventor has developed multi-layer holographic systems that use ultra-short throw (UST) projectors. UST projectors, as contrasted to normal projectors, do not require positioning at long (or far) distances from the projected screen as UST projectors are generally able to “throw” large images on closely proximal (e.g., closely located) projection screens. For example, at least some UST projectors can generate projected images of up to 100 feet with the projector placed only 15 feet away from the projected surface. In general, UST projectors can be located as close as about 1 to about 4 feet from a display screen, while still achieving full image display. In some cases, UST projectors can be defined as projectors that have a throw ratio of less than about 0.4, i.e., as compared to normal non-ultra short throw projectors which may have a throw ratio of between 0.4 and about 1.0. The throw ratio is generally calculated as throw distance divided by image width (i.e., throw ratio = throw distance/image width).

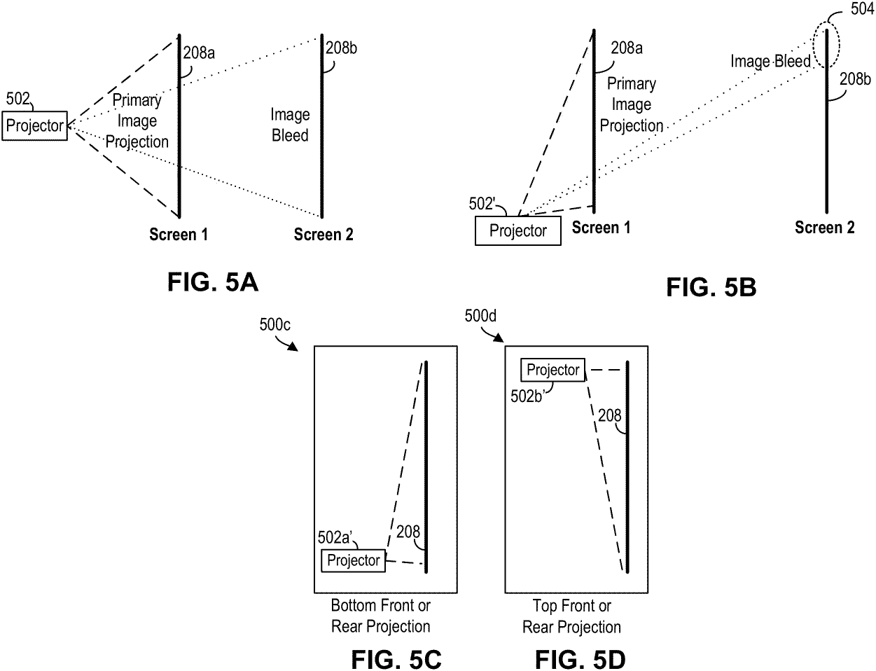

FIGS. 5A and 5B schematically illustrate the difference in operation between normal projectors and UST projectors. FIG. 5A shows an arrangement of screens 208a, 208b using a normal projector 502. As shown, the projector 502 is used to display images on a front projection screen 208a, and therefore must be placed at a distance from the projection screen 208a, such as to illuminate the entire projection screen and display a primary image projection. Despite the fact that the projector 502 is designated to project images only for the front projection screen 208a, owing to the partial transparency of the front projection screen 208a, the projected light may still bleed or “leak” through front screen mesh and spill onto the rearward second projection screen 208b. Accordingly, the second projection screen 208b not only displays its own image projections (i.e., from a second designated projector (not shown)), but also displays artifacts from the first projector 502. This, in turn, generates a “double imaging” problem on the second projection screen 208b. The problem of doubling imaging, as a result of employing normal projector devices, has been a significant factor in preventing the successful adoption of multi-layer hologram systems.

FIG. 5B shows an alternate arrangement using an UST projector 502'. The UST projector 502' can be positioned in close proximity (i.e., based on a desired amount of image spill and/or image bleeding) to the first screen 208a (e.g., on the ground or ceiling). As shown, as a result of the steep projection beam of the UST 502', the quantity of image spill on the second projection screen 208b is greatly reduced with only some image bleeding 604 affecting the top of the rearward screen 208b. The remaining image bleeding is cast, for example, on a ceiling or a backwall.

In view of the foregoing, the inventor has realized a unique application of recent UST projector technology for enabling multi-layer holographic systems.

In embodiments provided herein, the projectors may each be UST projectors. For example, as shown in FIGS. 5C ― 5D, UST projectors 502a' and 502b' can be placed in close proximity (e.g., based on image size, the projection angle and projection screen size) and near the bottom of the projection screen 208 such as to project upwardly (arrangement 500c in FIG. 5C) and/or near the top of the projection screen 208 such as to project at a steep angle downwardly (arrangement 500d in FIG. 5D). In various cases, the placement of the UST projectors may not exceed the height of the projection screen, which is not otherwise possible if normal projectors are oriented at similarly steep angles (i.e., normal projectors would be required to be placed above the screen, and a sufficient distance away). This, in turn, allows the use of UST projectors in restricted spacing settings. In at least some embodiments, each of the UST projectors is configured to generate a large image of about 16 ft x about 9 ft with the necessary lumens or brightness.

### II. Double Imaging

As described above, a significant challenge in realizing multi-layer hologram projection systems is reducing incidences of double imaging between projection screens. While the use of UST projectors greatly reduces this problem (see e.g., FIG. 5B), the use of UST projectors does not eliminate the problem entirely. For example, in FIG. 5B, residue image bleeding 504 may still overlap with approximately 20% of the rearward screen 208b. To address this problem, embodiments herein may use one or more mitigatory methods that include: (a) using overlapping scrims; and/or (b) using a dual projector arrangement.

### (a) Overlapping Scrims

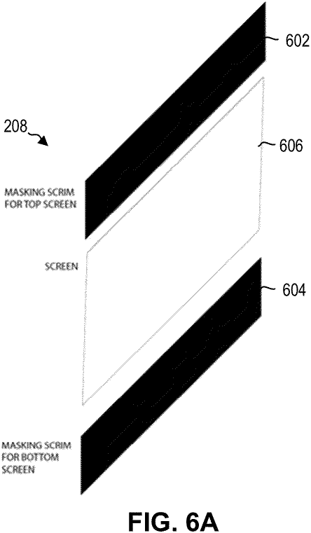

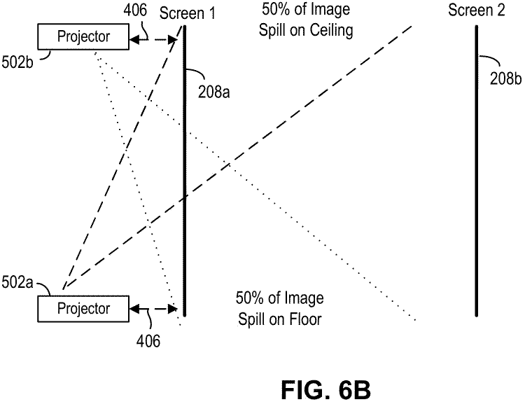

In at least one embodiment, a solid masking scrim may be placed over one or more of the top and bottom portions of the projection screen to cover the portion of the screen experiencing the effect of image bleeding (e.g., the middle layer projection screen 208b in FIG. 5B). For example, as shown in FIG. 6A, a top masking scrim 602a may be placed over a top portion of the screen 208, and/or a bottom masking scrim 604b may be placed over a bottom portion of the screen. In this arrangement, only a mid-screen portion 606a may be uncovered to display projections, and the scrims 602, 604 can be moved up or down as required to cover unwanted projections. The black solid scrims may cover or hide undesired secondary double images (i.e., 504 in FIG. 5B) as the double images are unviewable as a result of the masking scrims 602a, 604a. For example, in FIG. 5B, when using the single projector 502', the spill over onto the second screen 208b may be obscured from the observer’s view by the placement of the upper scrim 602.

### (b) Dual Projector Arrangement

In addition, or in the alternative, to using scrims, in at least some embodiments, a two projector arrangement can also be used to minimize the effects of double imaging.

FIG. 6B shows an example embodiment of a dual projector arrangement. As shown, a bottom projector 502a may be placed to project a first half of a projected image on a top portion of a front projection screen 208a, while a top projector 502b may be placed to project a second half of the image on a bottom portion of the front screen 208b. In this manner, each projector 502a and 502b is not required to project across the full height of the projection screen 208a (i.e., as shown in FIG. 5B). The result is that any projection light that passes through the front screen 208a is either projected on the floor or ceiling between the two screens 208a, 208b, thereby avoiding any incidences of image spill on the rearward screen 208b. In at least one embodiment, the top mounted projector 502b may be disposed upside down and may be configured to display a flipped image. In some embodiments, solid black scrims may still be used to cover the image spill on the ceiling or floor.

In at least one embodiment, as the projection screens are brought closer together, the likelihood of image bleeding increases, and therefore the projectors 502a and 502b may need to be separated from the screen 208a by a smaller distance 406. For example, in some cases, if there is a 20% double image spill between two projection screens that are spaced about 8 to about 10 ft apart, the double image spill would increase to 40% or more when the distances between the screens is reduced to about 4 to about 6 ft.

It is noted that in common industry language, the use of two projectors located one over the other is ordinarily referenced as “projector stacking”. Projector stacking, however, requires placing the projectors directly on top of each other, and may be used to increase the brightness (i.e., lumens) of the image by overlapping one projection image over top of another to generate the same image at the same location with increased brightness or lumens. The configuration exemplified in FIG. 6B has been uniquely realized by the inventor to prevent double-imaging in multi-layer hologram systems, and does not otherwise stack the projectors directly over each other, nor do the projectors project the same image. Rather, the projectors 502a and 502b in FIG. 6B are vertically spaced apart from each other (i.e., about 10 to about 30 feet, or spaced apart based on the screen height), and each projector 502a and 502b projects a different image (i.e., a top or bottom portion of the image).

### III. Image Bleeding

Another significant challenge in realizing multi-layer hologram projection systems is minimizing image bleeding when an image projected on a rearward projection screen (e.g., mid-screen 208b in FIG. 2A) overlaps with images projected on more forward projection screens (e.g., forward screen 208a in FIG. 2A).

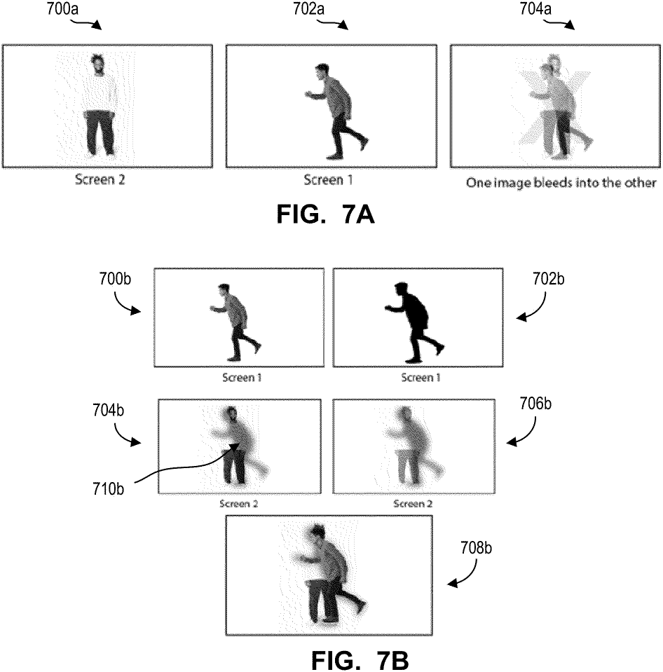

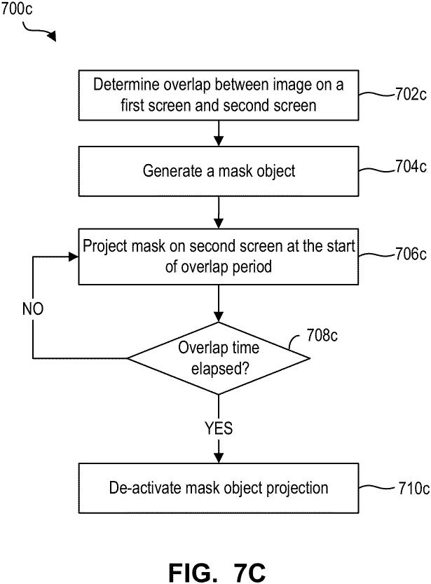

For example, as shown in FIG. 7A, a rearward screen may receive a projected secondary image (i.e., image 700a), while a forward screen may receive a projected primary image (i.e., image 702a). In this example, the primary image 702a on screen ‘1’ is a moving image (i.e., a running subject), while the secondary image 702b on screen ‘2’ is a stationary image (i.e., a standing subject). As the primary images moves across screen 1, it can be expected that the primary image 702a will “overlap” the stationary secondary image 702b for at least a temporary moment in time. This, in turn, can cause the two images 702a and 702b to “bleed” into each other (e.g., image 704a in FIG. 7A) from the viewer’s perspective. The problem of image bleeding can compound as the number of projection layers increases, and the number of overlapping objects similarly increases.

To at least partially mitigate this image bleeding effect, the inventor has realized a unique software masking tool. The software tool can be used to generate and project a masking shape, which may be referred to as an object mask, which may be done using a shadow mask that decreases the opacity of an image experiencing image bleed through. In at least one embodiment, the shape can be configured to appear and disappear, only when required, to provide the required “masking” effect.

FIG. 7B provides a number of images illustrating the concept of using projected masks to minimize image bleed through. As shown, using a masking effect, the first screen may still display the primary moving image (i.e., image 700b), however a shadow mask 710b may be projected on the second screen so as to overlap the secondary image (i.e., image 704b or 706b). In particular, the shadow mask 710b acts as a visual buffer between the primary and secondary images to reduce the image bleeding/blending effect (i.e., image 708b). The shadow mask 710b may take the shape or form of the overlapping image on screen ‘1’ (e.g., image 702b). The shadow masks are not projected on a separate layer, but rather, are directly projected onto the same layer displaying the projected secondary image.

In at least some embodiments, the shadow mask may take the shape of the primary image and may be generated using a gaussian blur (i.e., to appear as a natural shadow of the primary image). The shadow mask 710b may also be generated to be sufficiently opaque such as to mask the overlapped secondary image without entirely blocking out the secondary image. In at least one embodiment, the shadow mask may be only projected on the first and/or second screen at a time instance (or time range) when the primary and secondary images overlap, and may be made to automatically disappear after the images are no longer overlapping. For the period of time the shadow mask is activated, the mask may also be configured to cover only the area or portion of the secondary image which is being overlapped by the primary image.

Reference is now made to FIG. 7C, which shows an example embodiment of a method 700c for generating masks to prevent an image bleeding effect.

At act 702c, a positional overlap is determined to occur at a point in time (or in a time range) between a primary image being displayed on a first screen, and a secondary image being displayed on a second screen, whereby the second screen is positioned rearward of the first screen. For example, the positional overlap may be determined in advance based on a known output time schedule of video image content on separate screens.

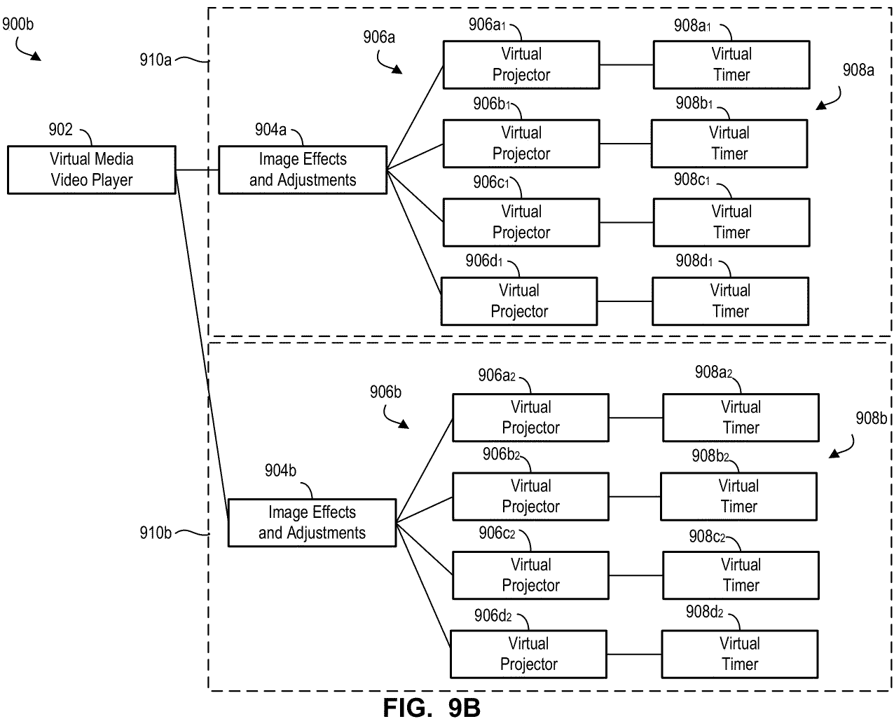

At act 704c, in response to determining the occurrence of an image overlap, a mask (i.e., a shadow mask) is generated. In at least some embodiments, the mask is generated to have a shape that is generally analogous to the portion of the primary image that is determined to overlap the secondary image. In at least some embodiments, the shadow is generated from an original Alpha channel image before contrast adjustment are made to convert the image to solid black. The solid black image is processed through a gaussian blur to generate a feathered edge appearing as a shadow. The image size (i.e., width and height) and opacity may be configured by using a virtual projector, in conjunction with a virtual timer (e.g., FIGS. 9A, 9B), that is used to control the virtual projector intensity to turn on and off the created shadow.

At act 706c, at the start of the overlap time period, the mask can be projected on the second screen and on top of the secondary image. The mask is projected to cover the area of the secondary image being overlapped by the primary image.

At 708c, a determination is made whether the overlap time period has elapsed. If not, the method 700 can return to act 706c to continue projecting the mask. Otherwise, at 710c, the mask can be automatically de-activated. As explained elsewhere herein, virtual timers can be used to individually monitor the activation and/or projection time of the mask.

### IV. Hardware System Configuration

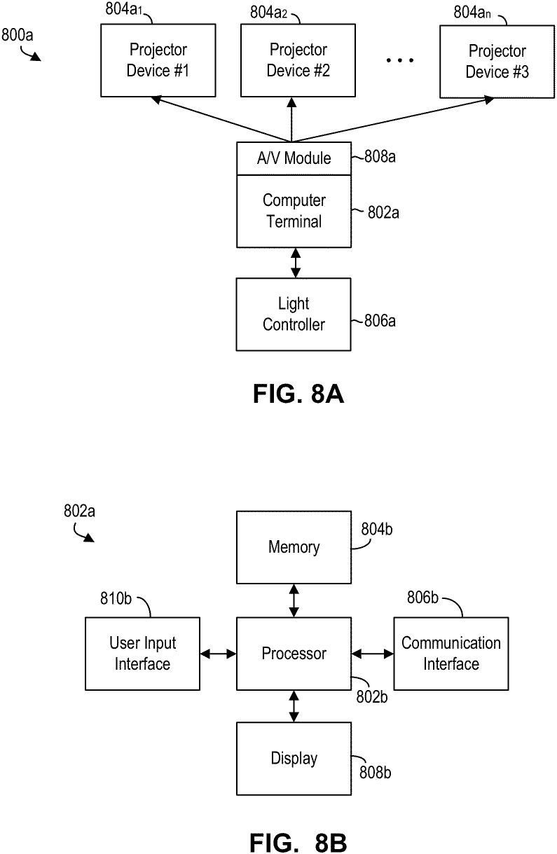

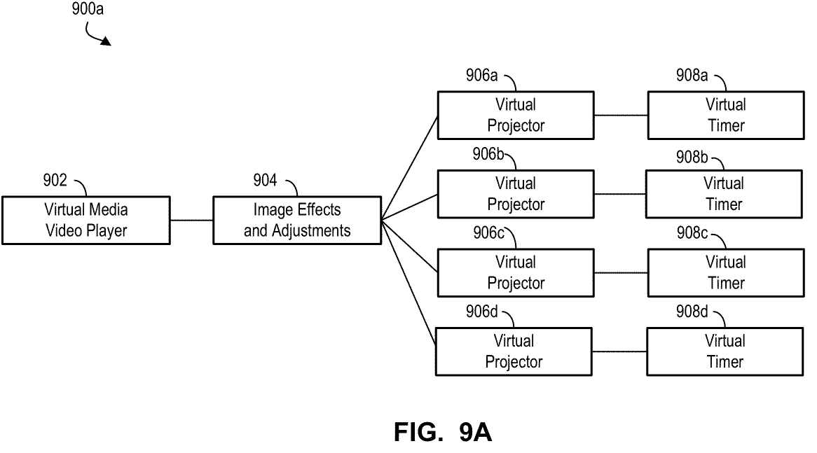

Reference is now made to FIG. 8A, which shows an example embodiment of a hardware configuration 800a for a multi-layer hologram projection system.

As shown, the system hardware configuration 800a can include a computer terminal 802a (which may also just be referred to as a computer) connected to one or more projector devices 804a₁- 804aₙ and/or a lighting controller 806a. In some embodiments, the computer 802a may include an audio/visual module 808a to control each of the projectors 804a. Computer 802a, projector devices 804a₁-804aₙ, light controller 806a and A/V module 808a may be analogous to computer 418, projector devices 402, light controller 416 and A/V operating system 412 in FIG. 4C, respectively. The connections between the computer 802a and the various other system components may be a wired or a wireless connection. In various cases, the connections may form a network that may be constructed from one or more computer network technologies, such as IEEE 802.3 (Ethernet), IEEE 802.11 and similar technologies.

Reference is now made to FIG. 8B, which shows an example embodiment of a simplified hardware block diagram of the computer 802a. As shown, the computer 802a may include a processor 802b which is coupled, via computer data bus, to one or more of a memory 804b, a communication interface 806b, a display 808b and/or a user input interface 810b.

Processor 802b is a computer processor, which may be implemented using a processor that provides sufficient computing power for controlling the projection systems described herein. For example, the computer processor may be implemented using a Graphics Processing Unit (GPU). In some embodiments, there might be more than one processor that is used which may be a combination of one or more CPUs and one or more GPUs. For simplicity of illustration one processor will be referred to herein. Processor 802b is coupled, via a computer data bus, to memory 804b.

Memory 804b may include both volatile and non-volatile memory. Non-volatile memory stores computer programs consisting of computer-executable instructions, which may be loaded into volatile memory for execution by processor 802b as needed. It will be understood by those of skill in the art that references herein to computer 802a as carrying out a function or acting in a particular way imply that processor 802b is executing instructions (e.g., a software program) stored in memory 804b and possibly transmitting or receiving inputs and outputs via one or more interfaces. Memory 804b may also be used to store data input to, or output from, processor 802b in the course of executing the computer-executable instructions. In at least one embodiment, memory 804b stores various software modules for controlling projectors 804a₁-804aₙ and light controller 806a (in some embodiments there might be more than one light controller).

Processor 802b is also coupled to display 808b, which is a suitable display for outputting information and data as needed by various computer programs. In particular, display 808b may display a graphical user interface (GUI).

Communication interface 806b is one or more data network interface, such as an IEEE 802.3 or IEEE 802.11 interface, for communication over a network.

User input interface 810b may include various data input devices, including keyboards, mouses, touchscreen(s), etc. and data output devices.

### V. Software Configuration and Custom Software Patches

The inventor has also appreciated that a further challenge in realizing multi-layer hologram projection systems is the lack of software solutions that enable such systems. More particularly, the inventor has developed software that allow multi-layered hologram projection systems where an operator may generate and control the concurrent display of hundreds to hundreds of thousands of projected images. For example, a five minute hologram projection of a music band can include projecting: (i) images of up to twelve (12) band members placed and staggered across three projection layers, (ii) six to thirty adjustable shadow masks for each band member to prevent image bleeding, (iii) twelve top shadow masks for the band to create stage to black, (iv) ten to one hundred hologram effects (or more) appearing on all scrims at staggered times, (v) ten to one hundred virtual light holograms to light the holograms or appear behind the holograms, as well as full audio adjustment, and full independent image control for each hologram and all additional standard video adjustments (i.e., keying and video mapping solutions).

Reference is now made to FIG. 9A, which shows an example embodiment of a block diagram 900a of interconnected software modules for controlling projected images in a multi-layer hologram projection system. The software modules illustrated in diagram 900a may be stored, for example, in the memory 804b of computer 802a and executed by computer processor 802b.

As shown, the software modules may include a virtual media player module 902 that feeds outputs into an image effects and adjustments module 904. The image effects and adjustments module 904 may, in turn, connect to one or more virtual projectors 906a ― 906d, each having a corresponding virtual timer 908a - 908d.

Virtual media play module 902 is a software module configured to control the output video clip being displayed, as well as the speed of displayed images from a given projector device and the output volume. In some embodiments, the virtual media play module 902 may also control the activation of the virtual projectors 906 (i.e., turning them on and off to reduce processing power), control the virtual timer (i.e., adjust the play length limit of a projected image), control the position of the video, enable looping of a video image, and control the video alpha channels.

Image effects and adjustments module 904 can receive, for example, the video output to be displayed and can further vary, in respect of various image objects in the video output, the contrast and hue of the image objects. The module 904 can also control alpha channel keying (i.e., keying out of colors to generate alpha channel), fade in and fade out of a wave generator (i.e., allowing images to fade in and fade out on any given screen, e.g., an FX loop), perform a dot matrix (i.e., converting an image to one that appears as an LED screen, i.e., pixelating the image) and act as a pulse generator (e.g., generate frequency pulses to add to FX). In at least some embodiments, module 904 may also control special effects for each image as well as create duplicate primary image shadow masks for masking purposes on other layers (i.e., to prevent bleed through of images). The image effects and adjustments module 904 may, in turn, connect to one or more virtual projectors 906a ― 906d. Each virtual projector 906 is associated with one or more actual projector devices (i.e., 804 in FIG. 8A). In general, virtual projectors are an output source that directs an image (video) to separate projectors or spaces in the overall image. In some cases, there may be a very large number of virtual projectors combining to create the overall presentation. Each virtual projector has the capacity of directing the signal having the images and/or masks to one or all projectors. Virtual projectors 906 are generally configured to each adjust and position images, independently, to generate a realistic effect and generate depth of field perception in multi-screen configurations. In various cases, in respect of separate images, virtual projectors 906 may control the horizontal and vertical position of the images, as well as the weight, height and zoom. In some cases, virtual projectors 906 may also control the transparency and intensity of the image.

In respect of each image object controlled by a virtual projector 906, a corresponding virtual timer 908a ― 908d may also be provided. Virtual timers allow for presenting dozens to hundreds of images by turning off and on corresponding virtual projectors to decrease CPU and/or GPU usage for multi-imaging multilayers. The virtual timers 908 may include timecodes for activating fade-in and out timers (e.g., timers to activate and de-activate virtual projectors). The virtual timers can also set the intensity of the corresponding projectors while fading in and out an image, and adjust the length of time set to fade an image in or out. In various cases, and in respect of the method 700c (FIG. 7C), virtual timers can also control the visibility of object mask projections to prevent image bleeding (i.e., acts 708c and 710c).

In at least one embodiment, two virtual projectors may be used along with blocking to display different portions of the same image. For example, as shown in FIG. 6B, to minimize double-imaging, a bottom projector 502a may display a top portion of an image (e.g., one portion of the image) and a top projector 502b may display a bottom portion of the same image (e.g., a remaining portion of the image). Accordingly, in these cases, the same hologram image may be provided to two virtual projectors 906, such that a given image is sent to the top projector and the same given image to the bottom projector. Accordingly, in these embodiments, using the image effects and controls module 904, 50% of the top projector image can be blacked out to only show the bottom half of the image, and the bottom projector can block out 50% of the bottom of the projected image. The end result is 100% of a full image being shown while projecting 50% of the image from the 2 projectors.

Reference is now made to FIG. 9B, which shows an example embodiment of a block diagram 900b of interconnected software modules for controlling projector devices of the multi-layer hologram projection system, according to some other embodiments. The program code for the software modules illustrated in diagram 900b may be also stored, for example, on the memory 804b of computer terminal 802a and executed by computer processor 802b.

The software modules in diagram 900b may be used to generate masks that minimize image bleeding (e.g., as shown in FIG. 7B).

As shown, a virtual media player 902 may couple to a primary software module block 910a and a secondary software module block 910b. Each of the primary and secondary software module blocks 910a, 910b include an image effects and adjustments module 904, one or more virtual projectors 906a, 906b and one or more corresponding virtual timers 908a, 908b.

In this configuration, the virtual media video player 902 plays an image for display, which may then be split into two separate images. In particular, the primary software module block 910a is used to generate the primary displayed image, and the secondary software module block 910b is used to generate a masking shadow of the primary image object. For example, using the image and effects and adjustments module 904b, in the secondary software module block 910b, a black silhouette (i.e., a black mask) of the primary image may be generated. The black silhouette is converted to generate a natural looking shadow that is projected (i.e., layered) on top of the underlying primary hologram image to prevent bleed-through. This does not black out the underlying hologram being overlapped, but only covers the portion of the hologram that is experiencing bleed through. This can be contrasted to systems which place the mask behind the hologram image to block out background light.

The generated shadow image may be sent to multiple virtual projectors to place one or many of the same shadow on multiple layers on multiple hologram images. In various cases, the shadow size and opacity as well as gaussian blur may be adjusted independently for each shadow such as to allow the shadow to be placed and look natural to be unnoticeable but still prevent bleed through on many projection layers. In at least some embodiments, each object or person in a multi-layer projection may have many shadows depending on the viewer’s perspective. The same process may be done with all hologram images to prevent bleed through that may require dozens of shadows operating at one time on many projection layers. Virtual Timers 908 may be used to turn on and off dynamic shadows to conserve CPU and GPU resources.

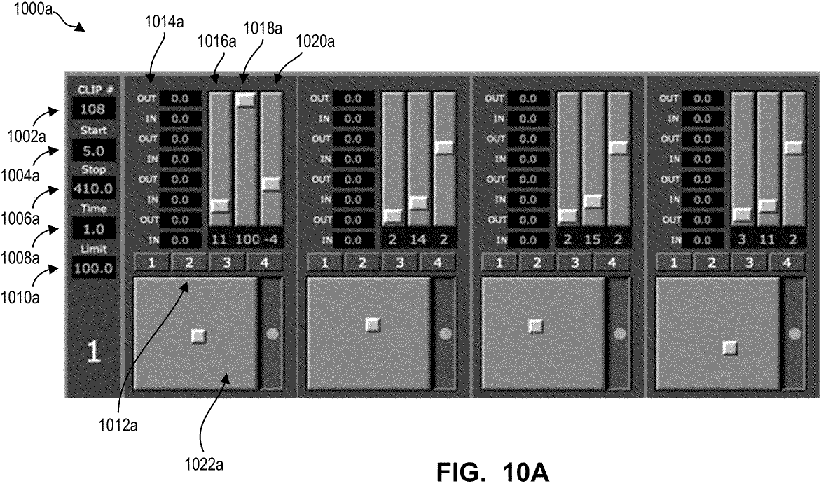

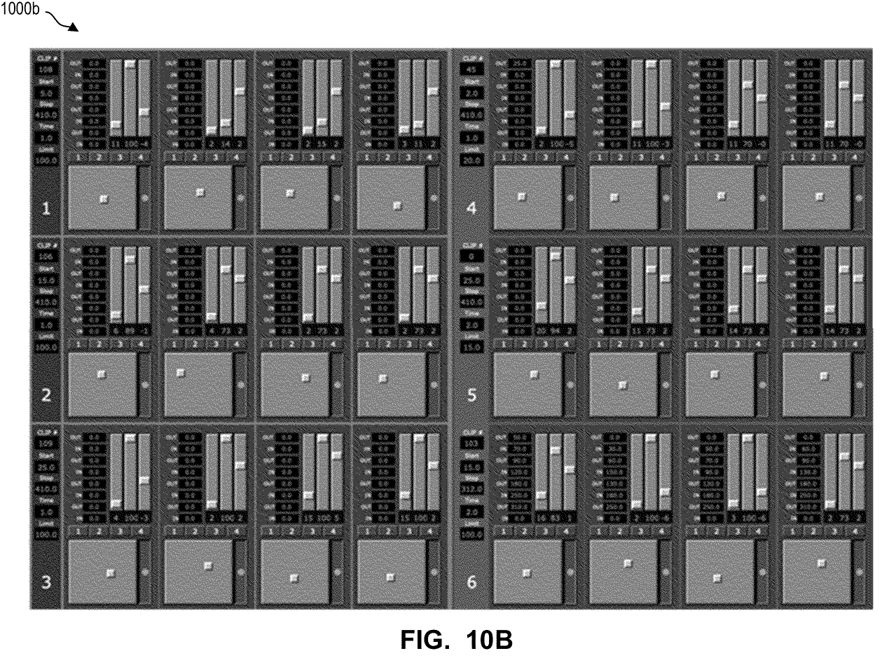

Reference is now made to FIG. 10A, which shows an example embodiment of a graphical user interface (GUI) 1000a for controlling virtual timers. The GUI 1000a may be displayed, for example, on a display 808b of a computer terminal 802a.

The GUI 1000a may include various fields, including a clip number 1002a, a start time 1004a, a stop time 1006a, a fade amount time 1008a and a limit field 1010a. The clip number 1002a expresses the actual video feed being played out, while the start and end times 1004a, 1006a express when the video feed starts and ends. The limit 1010a represents the fade amount of the video content. Buttons 1012a (e.g., screen buttons), numbered one to four, represent which projection layer the image will appear on. The out and in fields 1014a represent all the fade in and fade out times. In this case one image can be presented on multiple layers and appear multiple times. The first fader 1016a represents the zoom, the middle fader 1018a represents image contrast and the last fader 1020a represents the layer position of the image. The faders may be adjusted using the user input interface 810b of the computer 802a. The square 1022a represents horizontal and vertical position, with the orange circles to the left of the squares being the on/off for the virtual projector.

Reference is now made to FIG. 10B, which shows another example embodiment of a graphical user interface (GUI) 1000a for controlling virtual timers. In this case, each video effect has multiple timers and can be duplicated to process hundreds of images. This, in turn, gives the ability to adjust many images from one user interface to build a performance in real time on multi-layers to avoid bleed through.

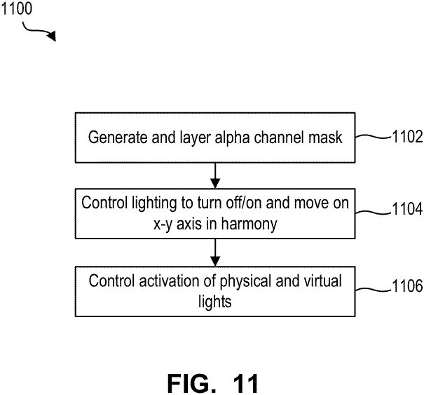

Reference is now made to FIG. 11, which shows an example embodiment of a method 1100 for virtual lighting of hologram objects using a multi-layer hologram projection system. Method 1100 may be performed, for example, by processor 802b of computing device 802a.

The inventor has appreciated a challenge in lighting holograms that are already lit using a multi-layer hologram projection system. In particular, using a physical light may light the hologram, but may also light the scrim and/or projection material that should appear transparent. Accordingly, embodiments herein may enable lighting hologram objects without lighting a hologram projection surface. In at least some embodiments provided herein, this can be performed by combining the ability to use physical lighting (e.g., real lighting, from moving and/or stationary light fixtures) in conjunction with virtual lighting that is projected onto the projection screens. The lighting effects can be controlled concurrently with the ability to adjust all lighting effects. In various cases, lighting is turned-on and faces away from a projection surface and is turned off when the lighting contacts the projection surface. At this point, virtual lighting may take over to light the hologram (rather than the projection surface).

As shown, at act 1102, an alpha channel mask is generated and layered so that a virtual lighting source remains between a hologram image that is to be lit and the alpha mask, thereby impacting only the image (i.e., alpha masking all object images except the target projected image). The mask does not allow virtual lighting to spill on the projection surface because it is layered under the alpha channel and on top of the projected hologram. The process is duplicated on additional layers to mask other images in a similar manner. The virtual lighting may also be controlled and placed individually according to the angle of the physical light by syncing the x-y properties of the physical light to the x-y properties of the virtual light.

At act 1104, after all virtual lighting is in place according to the fixed position of the physical light, the control of all lighting is programmed to turn on and off and/or move on an x-y axis in harmony as desired.

At act 1106, the physical lights may be programmed to turn on when visible to the audience, but turn off when the light comes in contact with a hologram projection scrim. At the point the virtual lighting turns on, and it can give the optics of the physical lighting being projected by a physical light fixture onto the hologram.

While the applicant’s teachings described herein are in conjunction with various embodiments for illustrative purposes, it is not intended that the applicant’s teachings be limited to such embodiments as the embodiments described herein are intended to be examples. On the contrary, the applicant’s teachings described and illustrated herein encompass various alternatives, modifications, and equivalents, without departing from the embodiments described herein, the general scope of which is defined in the appended claims.

Various embodiments in accordance with the teachings herein are described to provide an example of at least one embodiment of the claimed subject matter. No embodiment described herein limits any claimed subject matter. The claimed subject matter is not limited to devices, systems or methods having all of the features of any one of the devices, systems or methods described herein or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicant(s), inventor(s) or owner(s) do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the example embodiments described herein.

It should also be noted that the terms “coupled” or “coupling” as used herein can have several different meanings depending in the context in which these terms are used. For example, the terms coupled or coupling can have a mechanical, software or electrical connotation. For example, as used herein, the terms coupled or coupling can indicate that two elements or devices can be directly connected to one another or connected to one another through one or more intermediate elements or devices via an electrical or magnetic signal, electrical connection, an electrical element or a mechanical element depending on the particular context. Furthermore, coupled electrical elements may send and/or receive data.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the Disclosure provided herein are for convenience only and do not interpret the scope or meaning of the embodiments.

Similarly, throughout this specification and the appended claims the term “communicative” as in “communicative pathway,” “communicative coupling,” and in variants such as “communicatively coupled,” is generally used to refer to any engineered arrangement for transferring and/or exchanging information. Example communicative pathways include, but are not limited to, electrically conductive pathways (e.g., electrically conductive wires, electrically conductive traces), magnetic pathways (e.g., magnetic media), optical pathways (e.g., optical fiber), electromagnetically radiative pathways (e.g., radio waves), or any combination thereof. Example communicative couplings include, but are not limited to, electrical couplings, magnetic couplings, optical couplings, radio couplings, or any combination thereof.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as "to, at least, detect," to, at least, provide," "to, at least, transmit," and so on.

1. A system for multi-layer hologram projections, the system comprising:
at least two projection layers in a spaced-apart arrangement;
at least one layer-specific projector device associated with each of the at least two projection layers, each layer-specific projector device being configured to project one or more images on an associated projection layer; and
a processor coupled to each of the at least one layer-specific projector device, the processor being configured to control each layer-specific projector device to project one or more images on the corresponding projection layer.

2. The system of claim 1, wherein each of the layer-specific projector devices is an ultra-short throw projector.

3. The system claim 1, wherein the at least two projection layers comprise a first projection layer, a second projection layer and a third projection layer.

4. The system of claim 3, wherein the first and second projection layers are each formed of a holographic mesh, and the third layer is formed of a solid reflective projection material.

5. The system of claim 1, wherein each of the at least two projection layers has one of a planar shape and a curved shape.

6. The system of claim 1, further comprising a mobile trussing and crank stand assembly for supporting the at least two projection layers.

7. The system of claim 1, wherein a rearward layer of the at least two projection layers comprises at least one black scrim covering one or more of a top portion and a bottom portion of the layer.

8. The system of claim 1, wherein the at least one layer-specific projector device comprises a top projector device and a bottom projector device, and the processor is further configured to control the top projector device to display a portion of an image and the bottom projector device to display a remaining portion of the image.

9. The system of claim 1, wherein the processor is further configured to:
determine a time range of overlap between a primary image projected by a first layer-specific projector device on a first projection layer, and a secondary image projected by a second layer-specific projector device on a second projection layer;
generate an object mask corresponding in shape to the primary image;
control a third layer-specific projector device to project the object mask over the secondary image on the second projector layer during the time range; and
de-activate the object mask after the time range has elapsed.

10. The system of claim 9, wherein the object mask comprises a gaussian blur.

11. A method for creating multi-layer hologram projections comprising:
providing at least two projection layers in a spaced-apart arrangement;
providing at least one layer-specific projector device associated with each of the at least two projection layers, each layer-specific projector device being configured to project one or more images on an associated projection layer; and
controlling each layer-specific projector device to project one or more images on the corresponding projection layer.

12. The method of claim 11, wherein each of the layer-specific projector devices is an ultra-short throw projector.

13. The method of claim 11, wherein the at least two projection layers comprise a first projection layer, a second projection layer and a third projection layer.

14. The method of claim 13, wherein the first and second projection layers are each formed of a holographic mesh, and the third layer is formed of a solid reflective projection material.

15. The method of claim 11, wherein each of the at least two projection layers has one of a planar shape and a curved shape.

16. The method of claim 11, further comprising supporting the at least two projection layers on a mobile trussing and crank stand assembly.

17. The method of claim 11, wherein a rearward layer of the at least two projection layers comprises at least one black scrim covering one or more of a top portion and a bottom portion of the layer.

18. The method of claim 11, wherein the at least one layer-specific projector device comprises a top projector device and a bottom projector device, and the method further comprises: controlling the top projector device to display a portion of an image and the bottom projector device to display a remaining portion of the image.

19. The method of claim 11, further comprising:
determining a time range of overlap between a primary image projected by a first layer-specific projector device on a first projection layer, and a secondary image projected by a second layer-specific projector device on a second projection layer;
generating an object mask corresponding in shape to the primary image;
controlling a third layer-specific projector device to project the object mask over the secondary image on the second projector layer during the time range; and
de-activating the object mask after the time range has elapsed.

20. The method of claim 19, wherein the object mask comprises a gaussian blur.
